(19) United States
(12) Patent Application Publication
(10) Pub. No.: US 2014/0279681 A1
(43) Pub. Date: Sep. 18, 2014

(54) AUTOMATED INVESTMENT PORTFOLIO MANAGEMENT

(71) Applicant: NUKU INC., Seattle, WA (US)

(72) Inventor: Carson Cole, Seattle, WA (US)

(73) Assignee: NUKU Inc., Seattle, WA (US)

(21) Appl. No.: 13/830,422

(22) Filed: Mar. 14, 2013

(51) Int. Cl. G06Q 40/06

(52) U.S. Cl. CPC G06Q 40/06
USPC 705/36 R

(57) ABSTRACT

A computer-implemented asset management method automatically selects, creates, and maintains individual portfolios for investors. The method includes: receiving from a client, via one or more computer systems, a client plan that includes risk information indicative of a relative risk desired by the client; receiving client funds for investment; creating asset profiles for individual investment assets, respectively, at least some of the individual investment assets being securities; selecting for the client a personal subset of the investment assets based on the client plan and the asset profiles of the individual assets in the personal subset; and creating a personalized client portfolio of assets by automatically investing the client funds in the personal subset of the investment assets.

### BACKGROUND

1. Technical Field

The present disclosure relates to financial management, and more particularly, to automated management of client assets in individually tailored asset portfolios.

2. Description of the Related Art

Investors generally have two choices to invest in securities. First, they can directly acquire shares of stock through the advice and assistance of a full-service financial firm such as a brokerage, bank or other asset management firm. The financial firm provides investment advice to the investor in addition to purchasing the shares at a market on behalf of the investor, or a discount brokerage, such as Charles Schwab, which merely purchases the shares on behalf of the investor. Second, investors can purchase shares in a trust or fund that invests in a number of securities. Each of these two traditional investment options has disadvantages for the investor, some of which are described below.

A major disadvantage of funds is the inability to select individual securities to be included in, or excluded from, the fund's portfolio or even monitor the fund's selection of securities in real time. An investor can attempt to select the general type of securities by investing in a targeted fund, such as a computer technology fund, but that selection still provides the manager of the selected fund with wide discretion to select from hundreds of securities. In addition, except for some targeted funds, it is not possible for the investor to express any preferences regarding matters such as social or moral issues (such as not wanting to, or only wanting to, invest in companies that engage in business with certain governments or have operations in certain sectors, such as defense). Even in those few instances where a targeted fund exists for those types of preferences, the preferences that the investor can have reflected are, at best, very general with the investor having no ability to select specific stocks, either to include or exclude, from the portfolio.

Although investing directly in securities through a brokerage or other financial institution eliminates some of the drawbacks of mutual fund investing, such direct investing suffers from difficulties in creating a diversified portfolio on a cost effective basis. The obstacles to creating such a portfolio for the smaller investor have been the inability of the ordinary investor to be able to craft such a portfolio on his own, combined with the costs of engaging in the trading to create and maintain such a portfolio, and the inability to consummate trades in small quantities needed to create such a portfolio. The obstacles to maintain such a diversified portfolio of individual stocks may be even greater, because the investor would need to track constantly changing security prices and re-balance the portfolio periodically by buying and selling various securities.

In addition to prohibitive costs, ordinary investors possess neither the skills nor the tools to create and maintain a diversified portfolio with desired risk-return characteristics. To create such a portfolio, an investor needs to understand risk as it is defined from the perspective of portfolio theory, and have the data and the mechanism for analyzing the data to employ the theory. That data then needs to be correctly employed in connection with a trading system to allow for the cost effective creation and maintenance of the portfolio. There are various computer-based products that provide advice to investors on creating a diversified portfolio, but such systems still require investors to purchase the individual securities to create and maintain the diversified portfolio, or the advice is for the purchase of funds.

### BRIEF SUMMARY

One embodiment of the present disclosure is a computer-implemented asset management method that automatically selects, creates, and maintains individual portfolios for investors. The method includes: receiving from a client, via one or more computer systems, a client plan that includes instructions detailing risk information indicative of a relative risk desired by the client; receiving client funds for investment; creating asset profiles for individual investment assets, respectively, at least some of the individual investment assets being securities; selecting for the client a personal subset of the investment assets based on the client plan and the asset profiles of the individual assets in the personal subset; and creating a personalized client portfolio of assets by automatically investing the client funds in the personal subset of the investment assets.

One embodiment is a non-transitory computer readable medium storing instructions that, when executed by one or more computers, performs the method described above.

One embodiment is a computer system for managing assets that automatically selects, creates, and maintains individual portfolios for investors. The computer system includes:

a user interface configured to receive a client plan that includes risk information indicative of a relative risk desired by the client;

a research engine configured to receive asset profiles for individual investment assets, respectively, at least some of the individual investment assets being securities;

a portfolio engine configured to select for the client a personal subset of the investment assets based on the client plan and the asset profiles of the individual assets in the personal subset; and
an execution engine configured to create a personalized client portfolio of assets by automatically investing the client funds in the personal subset of the investment assets.

### BRIEF DESCRIPTION OF THE SEVERAL VIEWS OF THE DRAWINGS

FIG. 1 is a functional block diagram of a portfolio management system 10 according to one embodiment of the present disclosure.

FIG. 2 shows a website page of a website according to one embodiment of the present disclosure.

FIG. 2A shows another website page of the website according to one embodiment of the present disclosure.

FIG. 2B shows another website page of the website according to one embodiment of the present disclosure.

FIG. 3 shows another website page of the website according to one embodiment of the present disclosure.

FIG. 4 shows another website page of the website according to one embodiment of the present disclosure.

FIG. 5 is a flow diagram illustrating a method of creating and maintaining an actual client portfolio of assets according to one embodiment of the present application.

FIG. 6 is a flow diagram illustrating substeps of an execution step by the execution module.

FIG. 7 is a flow diagram illustrating a change in a client portfolio caused by changes in research information with respect to the assets in the client portfolio.

FIG. 8 shows one embodiment of a networked computer system upon which the portfolio management system can be implemented.

FIG. 9 shows of a suitable networked portfolio management environment in which the various illustrated embodiments can be implemented.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, server computers, and/or communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

This disclosure describes various systems, methods and articles related to electronic commerce and in particular evaluation of affiliates in electronic commerce. While specific structures and acts associated with particular illustrated embodiments are disclosed, other structures and acts may be employed in other embodiments.

Shown in FIG. 1 is a functional block diagram of a portfolio management system 10 according to one embodiment of the present disclosure. The portfolio management system 10 provides an automated platform that individually manages financial assets of a plurality of clients 12a-12n, collectively 12. The portfolio management system 10 interfaces with one or more custodians 14 that hold assets belonging to the client 12, and with financial markets 16 in which the clients' assets are being invested. It will be appreciated that the portfolio management system 10 may interface directly with the financial markets 16 or indirectly via a third-party trading system 18 that executes trades in the financial markets 16 based on instructions from the portfolio management system 10. In addition, the third party trader 18 may also be empowered to interface directly with the custodian 14 to obtain access to the clients' assets for trading in the financial markets 16.

The portfolio management system 10 includes a website 20 that provides the primary interface between the portfolio management system 10 and the clients 12. The term “website” is being used in a broad sense to indicate any site on any network. For example, the website 20 may be an actual website on the Internet, but it may also be implemented as a site on a company intranet or any other network. The website 20, of course, is interactive in that information is provided to the clients 12 and information and instructions can be received from the clients 12 to the portfolio management system 10. The portfolio management system 10 also includes a client information database 22 that receives and stores client information received via the website 20.

The portfolio management system 10 includes a research module 24 that stores asset profiles for each of a large number of investment assets. As used herein, “investment assets” refers to anything that is capable of being owned or controlled to produce value. The investment assets discussed herein primarily include securities that are traded on various financial markets, such as the financial markets 16. Such securities may include debt securities, such as bonds; equity securities, such as common stocks; and derivative contracts, such as futures, options, and swaps. Financial analysts individually research each investment asset and store in the research model various information regarding the asset, such as general information on the issuer, issuer sector and industry information, issuer historical financials, issuer documents, analyst opinions on issuer outlook, issuer risk ratings, risk that the issuer is exposed to, asset general information, asset documents, and analyst asset growth ratings. Based on all of that information input by the financial analyst, the research module 24 determines issuer rankings of risk and asset rankings of risk, income, and growth.

The portfolio management system 10 also includes an investment engine 26 that determines a portfolio map for the client based on a client plan received by the website 20 and stored in the client information database 22. The portfolio map includes a selection of investment assets that are determined to satisfy the client's plan based on the risk, income, and growth rankings of the assets and the levels of risk, growth, and income, and any other instructions indicated in the client's plan. Given that each client has an individual amount of funds to be invested and desires an individual amount of risk, growth, and income (and numerous other possible combinations of instructions, in their client plan, the portfolio map for each client will be different than the portfolio map for each of the other clients using the portfolio management system 10. Also, the investment engine 26 continually, such as on a daily basis, re-analyzes client plans, so the portfolio map created for a particular client may vary from day to day, or even more frequently.

In addition, the research module 24 continually, such as on a daily basis, updates the information on the individual investment assets, so the portfolio map created for a particular client may vary from day to day, or even more frequently. The financial analysts that set the asset profiles have the ability to increase/decrease the desirability to be in certain industries, geographic areas, and other identifiable risk exposures, which could apply to many client portfolios by increases/reductions in holdings. For example, the financial analysts could deem that oil prices are an increased risk, and change the rankings of various assets, such as those related to the oil industry or other assets likely to be affected by oil price increases. This may result in a decrease in overall oil-exposure.

The portfolio management system 10 includes an execution module 28, which determines the quantities of assets to buy or sell in a client account, and a pricing module 30 that obtains and stores pricing information for the assets. The execution module 28 determines the quantities of assets to buy or sell in a client account based on a portfolio map for the client, which provided by the engine 26; the pricing information for the assets in the portfolio, which is provided by the pricing module, and the client's existing portfolio information (if any), which is provided by the client information database. The execution module 28 then causes the various investment assets to be bought or sold at the financial markets 16 to obtain an actual investment portfolio for the client 12. The execution module 28 may trade directly with the financial markets 16 or indirectly via the third-party trading system 18.

As discussed above, one embodiment of the present disclosure employs a client plan that is a set of instructions that instruct the portfolio management system 10 to implement various financial desires of the client. Preferably, the client plan includes at least a goal instruction indicating the general goal(s) of the client's account and a profile instruction indicating the desired risk tolerance (safety versus risk), income, and growth. The goal and profile instructions provide the portfolio management system with sufficient information to manage the client's account. Other optional instructions may include:

exclude asset instruction—an instruction to not invest in a specific asset;

include asset instruction—an instruction to invest in a specific asset;

exclude industry instruction—an instruction to not invest in a specific industry;

exclude country instruction—an instruction to not invest in a specific country;

prefer socially-responsible investments instruction—an instruction to choose investments considered to be socially-responsible over investments that are not;

exclude socially-irresponsible investments instruction—an instruction to not invest in assets of companies that are considered socially-irresponsible;

optimize U.S. state taxes instruction—an instruction to attempt to optimize assets that are tax-beneficial for a specific U.S. state.

optimize U.S. federal taxes instruction—an instruction to attempt to optimize assets that are tax-beneficial for U.S. federal taxes including but not limited to limiting capital gains, encouraging long-term capital gains;

optimize for scheduled income instruction—an instruction to try to produce a set level of income at scheduled intervals, such as weekly, monthly, yearly or for a specific date in the future;

prefer country instruction—an instruction to choose investments that will give a higher exposure to a specific country; and

prefer industry/sector instruction—an instruction to choose investments that will give a higher exposure to a specific industry or sector.

FIG. 2 shows a website page 32A of the website 20 according to one embodiment of the present disclosure. The page 32A is a “Plan” page that includes a client plan display 34 that shows a set of instructions for a current client plan for the client. The client plan display 34 includes a goal instruction display 35 that displays a goal instruction of “Maximize Growth” and includes a selectable edit button 36 that enables the client to edit the goal instruction, as will be discussed below with respect to FIG. 2A. The client plan display 34 also includes a profile instruction display 37 that displays a profile instruction having percentage values for safety, risk, income, and growth and includes a selectable edit button 38 that enables the client to edit the safety, risk, income, and growth percentage values, as will be discussed below with respect to FIG. 2B

FIG. 2A shows a website page 32B that is accessible in response to the client selecting the edit button 36 of the goal instruction display 35 shown in FIG. 2. The website page 32B enables the client to edit the goal instruction for the client plan. The website page 32B includes a displayed list 39 of goal options that can be individually selected by the client simply by “clicking” on the circle next to the desired goal option. The goal options shown in the list 39 are common goal options that may be desired by the client, although one skilled in the art will recognize that various other options are possible. The website page 32B also includes a selectable save button 40A, which enables the client to save the selected goal option, and a selectable “return to plan” button 41A that enables the client to return to the Plan page 32A shown in FIG. 2.

FIG. 2B shows a website page 32C that is accessible in response to the client selecting the edit button 38 of the profile instruction display 37 shown in FIG. 2. The website page 32C includes an interactive safety/risk indicator 42 that shows the client's safety/risk level using numerical values and using a safety/risk slider 43 that graphically displays the relative risk and safety. FIG. 2B shows numerical values of 59% and 41% for the risk and safety, respectively, and shows the slider approximately 59% of the distance between the “safety” and “risk” to graphically indicate 59% safety. In one embodiment, the portfolio management system 10 initially sets the safety level to 100% to indicate portfolio of 100% cash.

The website page 32C also includes an interactive income/growth indicator 44 that shows the client's income/growth level using numerical values and using a income/growth slider 45 that graphically displays the relative income and growth levels desired by the client. FIG. 2 shows numerical values of 20% for income and 80% for growth, and shows the income/growth slider 45 approximately 80% of the distance between the “income” and “growth” labels to graphically indicate the 80% growth and 20% income. As noted above, the safety/risk slider 43 and the income/growth slider 45 are both interactive in that the client can move both sliders to change the desired safety, risk, income, and growth levels. Like the website page 32B, the website page 32C also includes a selectable save button 40B, which enables the client to save the selected client profile of risk, safety, growth, and income values, and a selectable “return to plan” button 41B that enables the client to return to the Plan page 32A shown in FIG. 2.

The website page 32A of FIG. 2 also includes a first user selection button 46A labeled “+Get Instructions” and a second user selection button 46B labeled “Preview Draft Plan”. The +Get Instructions button 46A enables the client to access other instructions, such as the optional instructions discussed above, in addition to the goal and profile instructions. After change one or more of the plan instructions, such as moving either of the sliders 43,45 to change either the risk/safety level or the income/growth level, the client can select the Preview Draft Plan button 46B to cause the investment engine 26 of the portfolio management system 10 to create a new portfolio map corresponding to changed risk/safety level or the income/growth level.

For example, assuming that the client has moved the income/growth slider 45 to select a growth level of 87%, the client can select the Preview Draft Plan button 46 to cause the investment engine 26 to display a proposed client portfolio corresponding to the changed portfolio map. FIG. 3 shows a website page 32D that includes a current holdings display 47A that lists the current holdings of the client portfolio based on the previous plan instructions and a proposed holdings display 48 that list proposed holdings for the client portfolio based on the change the growth level in the profile instruction from 80% to 87%. One can appreciate that the quantities, prices, and values listed in the table are exemplary only and not intended to represent actual numbers for the assets listed.

The website page 32D includes a Finalize New Plan button 49 that enables the client to submit their plan and regenerate a new portfolio map and cause the execution module 28 to arrange to buy or sell the assets that will produce an actual client portfolio corresponding to the new portfolio map. The execution module would calculate the quantities of assets that needed to be bought and sold in order to arrive at an actual client portfolio that conforms, at least closely, to the proposed client portfolio shown in the proposed holdings display 48 of FIG. 3. One will recognize that the prices at which the assets can be bought may have changed between the time that the client selected the Finalize New Plan button 49 and the time at which the asset purchases were consummated, so the quantities, prices, and values may not be identical to the quantities, prices, and values shown in the proposed holdings display 48 shown in FIG. 3. Also, the sale prices of the assets in the previous client portfolio might be different than the previous prices, so the money available to purchase the assets in the proposed client portfolio may have changed, which would also result in an actual new client portfolio having quantities, prices, and values that differ from the quantities, prices, and values shown in the proposed holdings display 48 shown in FIG. 3.

The website pages 32A-32D shown in FIGS. 2, 2A, 2B, and 3, respectively, also each include a Current button 50 and a Draft button 52. These are user selection buttons that enable the client to select current values for the items displayed on the website pages or edited draft values for those items. FIG. 4 shows a website page 32E of the website 20 according to one embodiment of the present disclosure. The website page 32E includes a client plan display 34B and a client holdings display 47B, and also includes an Asset Include section 54 and an Asset Exclude section 56. The Asset Include section 54 represents an instruction that allows the client to specify particular assets desired to be included within the client's investment portfolio. For example, the client may want to make sure that shares of the client's employer are always included in the client's portfolio. The Asset Include section 54 includes a symbol box 58 for entering the symbol of the asset to be included, a shares box 60 for entering a desired number of shares of the asset, and a percentage of holdings box 62 for entering a desired percentage value of the asset with respect to the total value of the client's portfolio.

The Asset Exclude section 56 represents an instruction that allows the client to specify particular assets desired to be partly or completely excluded from the client's investment portfolio. For example, the client may want to make sure that the client's portfolio does not include shares of particular tobacco companies or shares of companies doing business with particular disliked foreign governments. The Asset Exclude section 56 includes a symbol box 64 for entering the symbol of the asset to be excluded, a shares box 66 for entering a maximum number of shares of the asset, and a percentage of holdings box 68 for entering a maximum percentage value of the asset with respect to the total value of the client's portfolio.

The website page 34E also depicts another client portfolio in the client holdings display area 47B. Although the asset quantities, prices, and values are exemplary only, one can see that there are relatively more treasury bonds in the portfolio shown in FIG. 4 compared to the proposed and current portfolios of FIG. 3, which reflects the lower risk level of the client profile shown in FIG. 4 compared to the client profile of FIG. 2B.

In one embodiment, the portfolio management system 10 is also configured to enable each client to specify a date on which the client would like to withdraw funds from the portfolio. For example, the client could specify a date shortly before the client's child is to go to college or a date at which the client would like to retire. The investment engine 26 would be programmed to instruct the engine 28 to begin selling assets sometime before that date so that the client's portfolio will include sufficient cash on the date specified.

The website pages 34A-34E illustrate examples of user interfaces that enable a client to interface with the portfolio management system 10. The website pages 34A-34E of the user interface could be presented as a window or screen with a number of user interface components, for instance menus, panels, dialog boxes, radio buttons, expansion controls and plus/minus icons (i.e., icons the selection of which cause a hierarchical list to expand and contract). The terms window and screen are used interchangeably herein to refer to a portion of a user interface (e.g., graphical user interface or GUI), which is displayed on a display or monitor and which provides information (i.e., output) to a user and which may allow the user to provide instructions, commands or information (i.e., input) to a processor-based device or an application executing on a processor-based device. The client may manipulate any of the user selectable components, such as the sliders 40, 44 or the Current and Proposed buttons 50, 52, by selecting the desired user selectable component with a pointer, for example by manipulating a mouse, trackpad or trackball, touching a touch sensitive display, or tabbing using an appropriate tab key on a keyboard or keypad, or by speaking commands. In the case of the sliders 40, 44, the client can also move the sliders to adjust the respective safety/risk and income/growth levels using the same methods listed above for selecting the user selectable components.

FIG. 5 is a flow diagram illustrating a method of creating and maintaining an actual client portfolio of assets according to one embodiment of the present application. In step 70, the portfolio management system 10 receives information about the client via the website 20 in order to set up an account for the client. In step 71, the portfolio management system 10 obtains funds from the client for investing. Of course, the funds likely would be received in a virtual sense in that the client might simply electronically provide the funds to the custodian 14, which might even be the same institution in which the client's funds are already located. In step 72, the portfolio management system 10 initializes the client plan, including the goal, the risk/safety and growth/income profiles and the asset include/exclude, such as by setting the risk level to 0%.

Step 73 represents the receipt from the client of a request to preview a draft plan based on the initialized instructions or any changes in instructions entered by the client using one or more website pages, such as those shown in FIGS. 2A, 2B, and 4. The investment engine 26 then determines in step 74 whether the instructions in the plan are valid. For example, if the client selected a goal of “Maximize Growth” in the website page 32B of FIG. 2A and also entered a desired growth value of 20% in the website page 32C of FIG. 2B, then the investment engine 26 would determine that those instructions are inconsistent and would cause an error message to be displayed to the user in step 75. If the investment engine 26 determines in step 74 that the instructions in the plan are valid, then the investment engine 26 obtains a client portfolio based on the client plan in step 76 and displays the client portfolio on the website 20 in step 78.

The method goes to step 80 in which the portfolio management system 10 determines whether there has been any change in the client plan, such as by the client moving the safety/risk and income/growth sliders 43, 45. If not, then the website 20 simply continues to display the initial client portfolio and waits for further client input. In response to detecting in step 80 that the client has changed the client plan, such as by detecting that the client has moved the safety/risk slider 43 and selected the Preview Draft Plan button 46, the website 20 again determines whether the new client plan is valid in step 74. If the new client plan is determined to be valid in step 74, the website 20 causes the investment engine 26 to provide a proposed client portfolio based on the new client plan in step 76, which is then displayed by the website in step 78.

In step 82, the portfolio management system 10 determines whether the client has made a request to execute the proposed client portfolio, such as by selecting the Finalize New Plan button 49 shown in FIG. 3. If not, then the website 20 simply continues to display the portfolio in step 78. If the website 20 does receive a request to execute the draft client plan in step 82, then in step 83 the website causes the investment engine 26 to generate a new portfolio map, which is passed to the execution module 28 to create in step 84 an actual client portfolio corresponding to the new portfolio map.

FIG. 6 is a flow diagram illustrating the execution step 84 by the execution module 28. The execution module 28 starts by receiving the request to execute from the website 20 in step 86. The execution module 28 obtains information describing the current client portfolio from the client information database 22 in step 88 and obtains the proposed portfolio map from the investment engine 26 in step 90. In step 92, the execution module 28 determines whether a first one of the assets in the proposed portfolio map is a new asset (compared to the current client portfolio). If so, then in step 94 the execution module 28 buys (or causes the third party trader 18 to buy) the amount of the asset indicated by the proposed portfolio map. If the first asset is not a new asset, then in step 96 the execution module 28 determines the amount of the first asset to buy or sell to go from the amount of the asset in the current client portfolio to the amount of the asset indicated by the proposed portfolio map. In step 98, the execution module 28 buys or sells (or causes the third party trader 18 to buy or sell) the amount determined in step 96. After either of the steps 94, 98, the execution module 28 determines in step 100 whether there are more assets in the proposed portfolio map or the current client portfolio to analyze. If so, then the execution module 28 returns to execute steps 92-98 for the next asset. Upon determining in step 100 that there are no more assets, the execution module 28 provides the new client portfolio to the website 20 in step 102.

One skilled in the art will recognize that the execution module 28 does not necessarily execute all of the steps shown in FIG. 6 in the order that they are depicted. For example, the execution module 28 may simply determine all of the quantities of assets to be bought and sold and then execute the determined buys and sells to obtain the new client portfolio.

FIG. 7 is a flow diagram illustrating a change in a client portfolio caused by changes in research information with respect to the assets in the client portfolio. The flow diagram includes a step 104 in which the client sets or changes goals or other information in the client plan. The investment engine 26 obtains research information A from the research module 24 in step 106 and produces a portfolio map A in step 108. The execution module 28 produces the trades determined to obtain a client portfolio A in step 110 and causes the website 20 to display the client portfolio A to the client in step 112.

As discussed above with respect to FIG. 1, research analysts regularly perform research on a large number of investment assets available to the portfolio management system 10. At some point, such research will change the risk ratings of one or more of the assets in the client portfolio A according to step 114. As some point, the change in ratings will result in the investment engine 26 producing a new portfolio map B in step 116. Next, the execution engine 28 produces the trades determined to obtain a client portfolio B in step 118 and causes the website 20 to display the client portfolio B to the client in step 120.

Note that the steps 114-120 occur without any actions being required by the client. The research analysts are constantly, or at least regularly, performing research on the investment assets and updating the risk, income, and growth ratings in the research module 24 for each of the assets available to the portfolio management system 10. Such updating of the research module 24 might be done at regular intervals, such as once per day, or at irregular times, such as whenever a particular analyst is ready to update the research module 24 with new information. Similarly, the investment engine 26 could be configured to produce new portfolio maps at regular intervals, such as once per day, or at irregular times, such as whenever the research module 24 is updated with new information. Likewise, the execution module 28 could be configured to execute trades to convert the new client portfolio maps to new client portfolios at regular intervals, such as once per day, or at irregular times, such as whenever the investment engine 26 produces new portfolio maps.

In addition, the client portfolio may change over time based on one or more instructions. For example, one instruction discussed above is the instruction to withdraw funds periodically, such as weekly or monthly, or at a particular date. Every time the investment engine 26 analyzes the account, it will consider any scheduled withdrawals and create a portfolio that best achieves the availability of cash on the specific date. If the account is currently holding assets that are very liquid (can be sold easily, with no impact on price) and are expected to maintain their value, then these assets will be reduced by the requested amount closer to the date of expected withdrawal. If the assets in the account have the potential to vary widely in price between now and the scheduled withdrawal date, then the assets will be reduced by the desired amount closer to the current date, rather than closer to the withdrawal date.

In addition to the instructions discussed above, the investment engine 26 may also consider personal information of the client in creating the client portfolio. Such personal information may include age, percent of assets this account represents of all of the assets of the client; retirement status, employment status, and years of experience in investing. For example, if a client is of an advanced age, depends on the capital and income of their account, and has no other source of income, the investment engine 26 may select assets that give a higher priority to safety. Alternatively, if a client is young, working, and not dependent on the assets of this account for income, the investment engine 26 may select assets that give a higher priority to growth.

One skilled in the art will recognize that the portfolio management system 10 described above may provide numerous advantages compared to the prior art. Note that the lists of advantages described below are not intended to be exhaustive of all advantages and not every embodiment is required to provide all of the advantages. Compared to full service brokerages, the portfolio management system 10:

1) would be expected to be much less expensive because it does not require investment advisors;

2) provides an individually tailored portfolio designed to satisfy a client plan that includes risk/safety and income/growth goals compared to the broker/advisor simply suggesting individual “hot” stocks;

3) automatically creates and maintains a diversified portfolio aligned with the client's profile, rather than the client attempting, or not, to manually create and maintain such a portfolio with occasional advice from the broker.

Compared to discount brokerages, the portfolio management system 10:

1) provides a professionally managed investment portfolio that does not require clients to select individual assets;

2) provides an individually tailored portfolio designed to satisfy a client plan that includes risk/safety and income/growth goals;

3) automatically creates and maintains a diversified portfolio aligned with the client's profile, rather than the client attempting, or not, to manually create and maintain such a portfolio without any investment advice.

Compared to mutual fund investing, the portfolio management system 10:

1) enables clients to own individual stocks and other assets rather then shares of a fund that owns the assets;

2) provides a professionally managed investment portfolio that does not require clients to select individual mutual funds;

3) provides an individually tailored portfolio designed to satisfy a client plan that includes risk/safety and income/growth goals;

4) automatically creates and maintains a diversified portfolio aligned with the client's plan, rather than the client attempting, or not, to manually select mutual funds that may or may not be diversified or aligned with the client's goals.

FIG. 8 shows one embodiment of a networked computer system 130 upon which the portfolio management system 10 can be implemented. The networked computer system 130 includes a portfolio management server 132, a network 134, and a plurality of client computers 136a-136n (three shown, collectively 136) associated respectively with a plurality of clients 138a-138n (three shown, collectively 138). The portfolio management system 10 runs on the portfolio management server 132 and manages the individual investment portfolio of each of the clients 138 as discussed above. The network 134 can be any type of network, such as the Internet or an extranet.

Each client computer 136 may take a variety of forms which allow input and output by the corresponding client. For example, the client computers 136 may take the form of personal computers, laptop or notebook computers, or tablet computers. The client computers 136 may be communicatively coupled to the network 134 via one or more networks, for example one or more wired (e.g., electrical conductors, optical fibers) networks and/or wireless networks via one or more wireless access points.

The portfolio management server 132 may have one or more server computers 140 (only one illustrated) to provide electronic communications either externally with the network 134 and internally within the server 132. To handle the load of multiple client computers 136, the portfolio management server 132 will typically have more than one server computer 140. The portfolio management server 132 may include one or more terminals or personal computers 142 (only one shown), communicatively coupled to the server computer(s) 136 via one or more wired or wireless networks 144 (only one shown). The terminals or personal computers 142 allow input and output by an end user, such as the financial analysts providing the research information into the research module 24.

The portfolio management server 132 includes one or more non-transitory computer- or processor readable storage media 146. The non-transitory computer- or processor readable storage media 146 store the client information database 22, the research module 124, and the programming that implements the portfolio management system 10. In some implementations, the non-transitory computer- or processor readable storage medium or media 146 may be constituted by various types of storage media (e.g., hard drive, RAM).

FIG. 9 and the following discussion provide a brief, general description of a suitable networked portfolio management environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices, multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 9 shows a networked portfolio management environment 200 comprising one or more portfolio management server computer systems 202 (only one illustrated) and one or more associated non-transitory computer- or processor readable storage media 204 (only one illustrated). The associated non-transitory computer- or processor readable storage medium 204 is communicatively coupled to the portfolio management server computer system(s) 202 via one or more communications channels, for example one or more parallel cables, serial cables, or wireless channels capable of high speed communications, for instance via Firewire®.

The networked portfolio management environment 200 also comprises one or more client computer systems 206 (only one illustrated). The client computer systems 206 is communicatively coupled to the portfolio management server computer system(s) 202 by one or more communications channels, for example one or more wide area networks (WANs) 210, for instance the Internet using Internet protocols.

The networked portfolio management environment 200 may employ other computer systems and network equipment, for example additional servers, proxy servers, firewalls, routers and/or bridges. The portfolio management server computer system(s) 202 will at times be referred to in the singular herein, but this is not intended to limit the embodiments to a single device since in typical embodiments there may be more than one portfolio management server computer system(s) 202 involved. Unless described otherwise, the construction and operation of the various blocks shown in FIG. 2 are of conventional design. As a result, such blocks need not be described in further detail herein, as they will be understood by those skilled in the relevant art.

The portfolio management server computer system(s) 202 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and/or a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the master node server computer system 202, such as during start-up.

The portfolio management server computer system(s) 202 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer-readable instructions, data structures, program modules and other data for the master node server computer system 202. Although the depicted portfolio management server computer system(s) 202 is illustrated employing a hard disk 224, optical disk 228 and magnetic disk 230, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to implement the various components of the portfolio management system 10. The system memory 214 may also include communications programs, for example a server 244 that causes the master node server computer system 202 to serve website pages via corporate intranets, extranets, or other networks as described below. The server 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable severs may be commercially available such as those from Mozilla, Google, Microsoft and Apple Computer.

While shown in FIG. 9 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the management system server computer system(s) 202 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The portfolio management server computer system(s) 202 can include other output devices, such as speakers, printers, etc.

The portfolio management server computer system(s) 202 can operate in a networked environment using logical connections to one or more remote computers and/or devices. Communications may be via a wired and/or wireless network architecture, for instance wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the portfolio management server computer system(s) 202 and client computer systems 206.

The client computer systems 206 will typically take the form of end user processor-based devices, for instance personal computers (e.g., desktop or laptop computers), netbook computers, tablet computers and/or smartphones and the like, executing appropriate instructions. These end user processor-based devices may be communicatively coupled to one or more server computers. The client computer systems 206 may include one or more processing units 268, system memories 269 and a system bus (not shown) that couples various system components including the system memory 269 to the processing unit 268.

The processing unit 268 may be any logic processing unit, such as one or more central processing units (CPUs), digital signal processors (DSPs), application-specific integrated circuits (ASICs), field programmable gate arrays (FPGAs), etc. Non-limiting examples of commercially available computer systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Unless described otherwise, the construction and operation of the various blocks of the satellite node server computer systems 206 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270 and random access memory (“RAM”) 272. A basic input/output system (“BIOS”) 271, which can form part of the ROM 270, contains basic routines that help transfer information between elements within the end user computer systems 206, such as during start-up.

The client computer systems 206 may also include one or more media drives 273, e.g., a hard disk drive, magnetic disk drive, WORM drive, and/or optical disk drive, for reading from and writing to computer-readable storage media 274, e.g., hard disk, optical disks, and/or magnetic disks. The computer-readable storage media 274 may, for example, take the form of removable media. For example, hard disks may take the form of a Winchester drives, and optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program modules and other data for the client computer systems 206. Although described as employing computer-readable storage media 274 such as hard disks, optical disks and magnetic disks, those skilled in the relevant art will appreciate that end user computer systems 206 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, electronic or digital documents or files or data (e.g., metadata, ownership, authorizations) related to such can be stored in the computer-readable storage media 274.

Program modules, such as an operating system, one or more application programs, other programs or modules and program data, can be stored in the system memory 269. Program modules may include instructions for accessing websites, extranet site or other site or services (e.g., Web services) and associated WebPages, other pages, screens or services hosted by the portfolio management system 132. Program modules may include instructions for storing electronic or digital documents or files or changes thereto to non-transitory computer- or processor readable storage medium, such as local media 274, or remote media 142 (FIG. 8), 204, 226, 232, 234.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method of managing assets, comprising:
receiving from a client, via one or more computer systems, a client plan that includes risk information indicative of a relative risk desired by the client;
receiving client funds for investment;
creating asset profiles for individual investment assets, respectively, at least some of the individual investment assets being securities;
selecting for the client a personal subset of the investment assets based on the client plan and the asset profiles of the individual assets in the personal subset; and
creating a personalized client portfolio of assets by automatically investing the client funds in the personal subset of the investment assets.

2. The method of claim 1, wherein the client plan further includes growth information indicative of a growth level of assets desired by the client and income information indicative of an income producing level of assets desired by the client.

3. The method of claim 1, further comprising creating a proposed personal client portfolio of assets based on the selected personal subset and displaying the proposed personal client portfolio of assets, wherein the automatically investing is performed in response to obtain client approval of the client plan.

4. The method of claim 1, further comprising:
after creating the personalized client portfolio of assets, adjusting the asset profile of one of the investment assets that is not in the personal subset;
automatically creating an adjusted personalized client portfolio of assets that includes the one of the investment assets by steps including:
determining, based on the adjusted asset profile, that an investment in the one of the investment assets would enable the personalized client portfolio of assets to better fit the client plan; and
automatically investing in the at least one of the investment assets based on the determining.

5. The method of claim 1, further comprising:
tracking price changes of the investment assets in the personalized client portfolio of assets; and
automatically adjusting quantities of the investment assets in the personalized client portfolio of assets based on the price changes and the client plan.

6. The method of claim 1, further comprising:
receiving an updated client plan from the client; and
automatically adjusting the personalized client portfolio of assets based on the updated client plan.

7. The method of claim 1, wherein the automatically adjusting includes:
selecting from the investment assets an additional asset, which was not one of the investment assets in the personal subset, based on the updated client plan; and
automatically investing in the additional asset.

8. The method of claim 1, further comprising:
after creating the personalized client portfolio of assets, adjusting the asset profiles of at least some of the investment assets in the personal subset;
automatically adjusting quantities of the investment assets in the personalized client portfolio of assets based on the adjusted asset profiles and the client plan.

9. The method of claim 1, wherein:
creating the asset profiles includes, for each of the investment assets, determining a risk ranking for the investment asset based at least in part on risk information regarding an issuer of the investment asset; and
selecting for the client the personal subset includes evaluating the risk rankings of the investment assets with respect to the relative risk desired by the client.

10. The method of claim 1, wherein:
creating the asset profiles includes, for each of the investment assets, determining a risk, growth, and income production rankings for the investment asset based at least in part on information regarding an issuer of the investment asset;
receiving the client plan includes receiving risk, growth, and income production goals desired by the client; and
selecting for the client the personal subset includes evaluating the risk, growth, and income production rankings of the investment assets with respect to the risk, growth, and income production goals desired by the client.

11. The method of claim 1, further comprising:
receiving from the client, via the one or more computer systems, an investment preference request that indicates a specific investment asset that is desired to be included in or excluded from the personalized client portfolio of assets, wherein selecting the personal subset includes selecting the personal subset based in part on the investment preference request.

12. The method of claim 1, further comprising:
receiving from the client, via the one or more computer systems, an industry preference request that indicates a specific industry that is desired to be included in or excluded from the personalized client portfolio of assets, wherein selecting the personal subset includes selecting the personal subset based in part on the industry preference request.

13. The method of claim 1, further comprising:
receiving from the client, via the one or more computer systems, a withdrawal request to withdraw an amount of cash at a future date; and
automatically managing the personalized client portfolio of assets so that the personalized client portfolio of assets includes a cash amount equal to or greater than the amount of cash indicated by the withdrawal request.

14. A non-transitory computer readable medium storing instructions that, when executed by one or more computers, perform a method comprising:
receiving via one or more computer systems a client plan that includes risk information indicative of a relative risk desired by the client;
receiving client funds for investment;
creating asset profiles for individual investment assets, respectively, at least some of the individual investment assets being securities;
selecting for the client a personal subset of the investment assets based on the client plan and the asset profiles of the individual assets in the personal subset; and
creating a personalized client portfolio of assets by automatically investing the client funds in the personal subset of the investment assets.

15. The non-transitory computer readable medium of claim 14, wherein the client plan further includes growth information indicative of a growth level of assets desired by the client and income information indicative of an income producing level of assets desired by the client.

16. The non-transitory computer readable medium of claim 14, wherein the method includes creating a proposed personal client portfolio of assets based on the selected personal subset and displaying the proposed personal client portfolio of assets, wherein the automatically investing is performed in response to obtain client approval of the proposed personal client portfolio of assets.

17. The non-transitory computer readable medium of claim 14, wherein the method includes:
after creating the personalized client portfolio of assets, adjusting the asset profile of one of the investment assets that is not in the personal subset;
automatically creating an adjusted personalized client portfolio of assets that includes the one of the investment assets by steps including:
determining, based on the adjusted asset profile, that an investment in the one of the investment assets would enable the personalized client portfolio of assets to better fit the client plan; and
automatically investing in the at least one of the investment assets based on the determining.

18. The non-transitory computer readable medium of claim 14, wherein the method includes:
tracking price changes of the investment assets in the personalized client portfolio of assets; and
automatically adjusting quantities of the investment assets in the personalized client portfolio of assets based on the price changes and the client plan.

19. The non-transitory computer readable medium of claim 14, wherein the method includes:
receiving an updated client plan from the client; and
automatically adjusting the personalized client portfolio of assets based on the updated client plan.

20. The non-transitory computer readable medium of claim 14, wherein the automatically adjusting includes:
selecting from the investment assets an additional asset, which was not one of the investment assets in the personal subset, based on the updated client plan; and
automatically investing in the additional asset.

21. The non-transitory computer readable medium of claim 14, wherein the method includes:
after creating the personalized client portfolio of assets, adjusting the asset profiles of at least some of the investment assets in the personal subset;
automatically adjusting quantities of the investment assets in the personalized client portfolio of assets based on the adjusted asset profiles and the client plan.

22. The non-transitory computer readable medium of claim 14, wherein:
creating the asset profiles includes, for each of the investment assets, determining a risk ranking for the investment asset based at least in part on risk information regarding an issuer of the investment asset; and
selecting for the client the personal subset includes evaluating the risk rankings of the investment assets with respect to the relative risk desired by the client.

23. The non-transitory computer readable medium of claim 14, wherein:
creating the asset profiles includes, for each of the investment assets, determining a risk, growth, and income production rankings for the investment asset based at least in part on information regarding an issuer of the investment asset;
receiving the client plan includes receiving risk, growth, and income production goals desired by the client; and
selecting for the client the personal subset includes evaluating the risk, growth, and income production rankings of the investment assets with respect to the risk, growth, and income production goals desired by the client.

24. The non-transitory computer readable medium of claim 14, wherein the method includes:
receiving from the client, via the one or more computer systems, an investment preference request that indicates a specific investment asset that is desired to be included in or excluded from the personalized client portfolio of assets, wherein selecting the personal subset includes selecting the personal subset based in part on the investment preference request.

25. The non-transitory computer readable medium of claim 14, wherein the method includes:
receiving from the client, via the one or more computer systems, an industry preference request that indicates a specific industry that is desired to be included in or excluded from the personalized client portfolio of assets, wherein selecting the personal subset includes selecting the personal subset based in part on the industry preference request.

26. The non-transitory computer readable medium of claim 14, wherein the method includes:
receiving from the client, via the one or more computer systems, a withdrawal request to withdraw an amount of cash at a future date; and
automatically managing the personalized client portfolio of assets so that the personalized client portfolio of assets includes a cash amount equal to or greater than the amount of cash indicated by the withdrawal request.

27. A computer system for managing assets, comprising:
a user interface configured to receive a client plan that includes risk information indicative of a relative risk desired by the client;
a research engine configured to receive asset profiles for individual investment assets, respectively, at least some of the individual investment assets being securities;
a portfolio engine configured to select for the client a personal subset of the investment assets based on the client plan and the asset profiles of the individual assets in the personal subset; and
an execution engine configured to create a personalized client portfolio of assets by automatically investing the client funds in the personal subset of the investment assets.
